(19) United States
(12) Patent Application Publication
(10) Pub. No.: US 2011/0128305 A1
(43) Pub. Date: Jun. 2, 2011

(54) DISPLAY APPARATUS AND METHOD

(75) Inventor: Masayoshi SHIMIZU, Kawasaki (JP)

(73) Assignee: FUJITSU LIMITED, Kawasaki-shi (JP)

(21) Appl. No.: 12/953,093

(22) Filed: Nov. 23, 2010

(30) Foreign Application Priority Data
Nov. 30, 2009 (JP) 2009-272825

(51) Int. Cl. G09G 5/10

(52) U.S. Cl. 345/690

(57) ABSTRACT

A display apparatus in which a plurality of light sources emit light to a pixel includes a correction unit configured to correct a luminance distribution of a display target image or a light emission distribution obtained when the plurality of light sources emit light at a certain light emission intensity so that an interval between the luminance distribution and the light emission distribution is increased; and a control unit configured to control an amount of light emitted from each of the plurality of light sources based on the luminance distribution or the light emission distribution corrected by the correction unit.

### CROSS-REFERENCE TO RELATED APPLICATIONS

This application is based upon and claims the benefit of priority of the prior Japanese Patent Application No. 2009-272825 filed on Nov. 30, 2009, the entire contents of which are incorporated herein by reference.

### FIELD

Embodiments described herein relate to a display apparatus and a display method.

### BACKGROUND

There are display apparatuses such as transmissive liquid crystal display apparatuses including a liquid crystal panel capable of changing a transmissive state of light and a backlight for supplying light to the undersurface of the liquid crystal panel. For example, the following technique has been proposed for reducing the amount of light to be emitted from a light source such as a backlight when the environment of a display apparatus is dark.

Japanese Unexamined Patent Application Publication No. 2006-147573 discloses a display apparatus that has a plurality of light sources having different light emission areas and separately controls the amounts of light to be emitted from the light sources in accordance with the luminance level of a displayed image. A technique for simultaneously reducing the amounts of light to be emitted from light sources in accordance with an illumination level in a surrounding environment detected by an illumination detection sensor is also disclosed. The display apparatus disclosed in Japanese Unexamined Patent Application Publication No. 2006-147573 may reduce power consumption caused by light emission performed by a plurality of light sources.

### SUMMARY

According to an aspect of the invention, a display apparatus in which a plurality of light sources emit light to a pixel includes a correction unit configured to correct a luminance distribution of a display target image or a light emission distribution obtained when the plurality of light sources emit light at a certain light emission intensity so that an interval between the luminance distribution and the light emission distribution is increased; and a control unit configured to control an amount of light emitted from each of the plurality of light sources based on the luminance distribution or the light emission distribution corrected by the correction unit.

The object and advantages of the invention will be realized and attained by at least the features, elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram describing a display apparatus according to a first embodiment.

FIG. 2 is a diagram illustrating a relationship according to the first embodiment between a luminance distribution and a combined light emission distribution.

FIG. 3 is a diagram illustrating the configuration of a display apparatus according to a second embodiment of the present invention.

FIG. 4 is a diagram illustrating examples of light emission patterns formed by light sources.

FIG. 5 is a diagram illustrating an example case in which a reduced image is divided into areas.

FIG. 6 is a diagram describing an example method of generating line information.

FIG. 7 is a diagram illustrating an example comparison according to the second embodiment between a luminance distribution pattern and a combined light emission pattern.

FIG. 8 is a diagram describing reduction rate adjustment processing according to the second embodiment.

FIG. 9 is a diagram describing reduction rate adjustment processing according to the second embodiment.

FIG. 10 is a diagram illustrating a process performed by a display apparatus according to the second embodiment.

FIG. 11 is a diagram illustrating a process performed by a display apparatus according to the second embodiment.

FIG. 12 is a diagram illustrating a process performed by a display apparatus according to the second embodiment.

FIG. 13 is a diagram illustrating an example area division performed to select a light source nearest to a portion to which the smallest amount of light is supplied.

FIG. 14 is a diagram illustrating an example of a computer for performing display control processing.

### DESCRIPTION OF EMBODIMENTS

With the above-described technique in the related art, there is a limit to the amount of reducible power. For example, in the above-described technique in the related art, simple control processing for reducing the amount of light to be emitted from each light source in accordance with an illumination level in a surrounding environment is performed. Only a certain amount of reduction in power consumption caused by light emission performed by each light source may be achieved with the above-described technique in the related art.

Accordingly, it is an object in one aspect of the embodiments to provide a display apparatus and a display method capable of further reducing power consumption caused by light emission performed by a plurality of light sources.

### First Embodiment

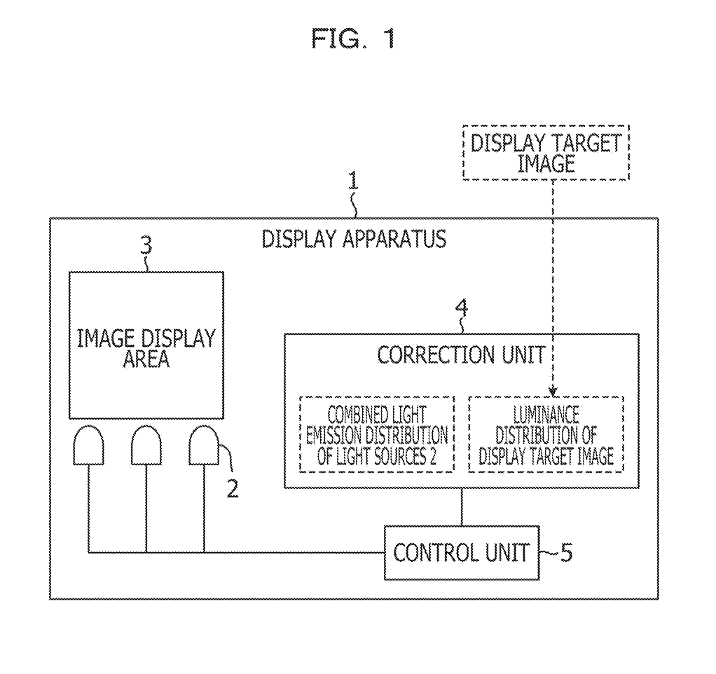

FIG. 1 is a diagram illustrating a display apparatus according to the first embodiment. A display apparatus 1 according to the first embodiment includes a plurality of light sources 2 having light emission ranges that overlap one another, an image display area 3, a correction unit 4, and a control unit 5.

In order to increase the interval between a luminance distribution of a display target image and a combined light emission distribution obtained by causing the light sources 2 to emit light at a certain light emission intensity, the correction unit 4 corrects the luminance distribution or the combined light emission distribution. The amount of light emitted corresponds to a light emission intensity. For example, a certain light emission intensity is the maximum light emission intensity.

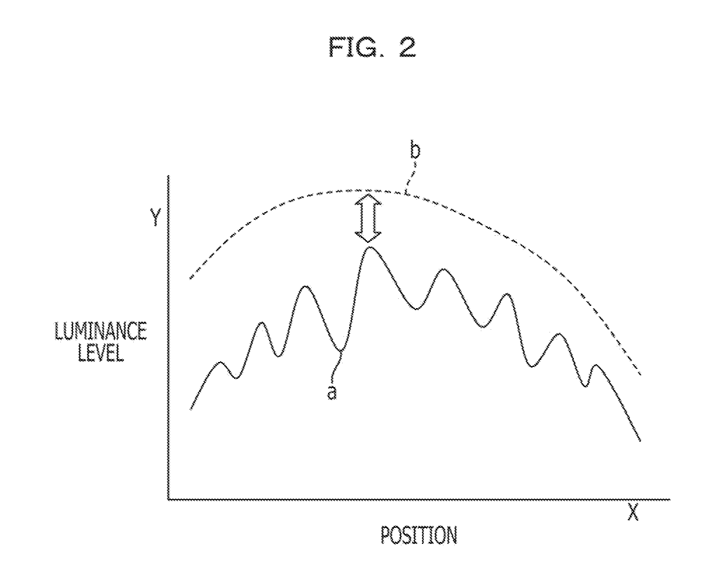

FIG. 2 is a diagram illustrating a relationship according to the first embodiment between a luminance distribution and a combined light emission distribution. In FIG. 2, a horizontal axis X represents a certain position in the image display area 3 in the horizontal direction parallel to a direction in which the light sources 2 are arranged, a vertical axis Y represents a luminance level at the certain position, a represents the distribution of luminance levels of a display target image at the certain position, and b represents a combined light emission distribution obtained when the light sources 2 emit light at a certain light emission intensity at the certain position. The luminance distribution is a luminance distribution required for a display target image. The combined light emission distribution is obtained by combining light emission distributions of lights supplied from the light sources 2. The correction unit 4 corrects the luminance distribution represented by a in FIG. 2 or the combined light emission distribution represented by b in FIG. 2 so as to increase the interval between the luminance distribution and the combined light emission distribution. The interval corresponds to the difference between a and b, and is represented by an arrow between a and b in FIG. 2.

The control unit 5 controls the light emission intensity of each of the light sources 2 on the basis of the luminance distribution or the combined light emission distribution corrected by the correction unit 4.

The display apparatus 1 according to the first embodiment corrects a luminance distribution of a display target image or a combined light emission distribution formed by the light sources 2 so as to increase the interval between the luminance distribution and the combined light emission distribution, and controls the light emission intensity of each of the light sources 2 after increasing the interval. In order to increase the interval, for example, a method of reducing the level of the luminance distribution a of a display target image or a method of increasing the level of the combined light emission distribution b formed by a plurality of light sources is used. Detailed description thereof will be made later.

The effect of reducing power consumption caused by light emission performed by light sources will be described. The display apparatus 1 includes a plurality of light sources having light emission ranges that overlap one another. For example, a single pixel in the image display area 3 receives light from a plurality of light sources. Accordingly, since the luminance level of a single pixel is achieved with light emitted from a plurality of light sources, light emitted from the light sources is effectively used. For example, according to this embodiment, the number of light sources whose light emission intensity may be reduced to reduce power consumption is increased from one to two or more. Accordingly, the display apparatus 1 according to this embodiment may reduce a large amount of power consumption.

### Second Embodiment

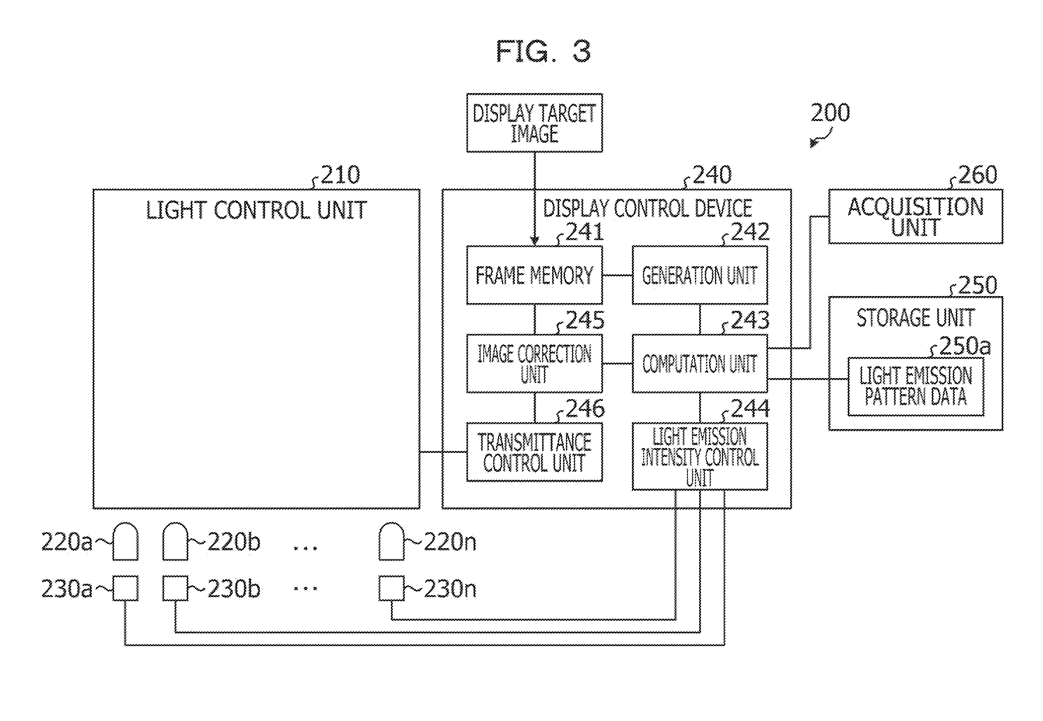

FIG. 3 is a diagram illustrating the configuration of a display apparatus according to the second embodiment of the present invention. A display apparatus 200 includes a light control unit 210, light sources 220a to 220n, drivers 230a to 230n, a display control device 240, and a storage unit 250.

For example, the storage unit 250 may be a semiconductor memory device such a Random Access Memory (RAM), a Read-Only Memory (ROM), or a flash memory or a storage device such as a hard disk or an optical disc. For example, the display control device 240 is an integrated circuit such as an Application Specific Integrated Circuit (ASIC) or a Field Programmable Gate Array (FPGA) or an electronic circuit such as a Central Processing Unit (CPU) or a Micro Processing Unit (MPU).

The light control unit 210 is, for example, a liquid crystal panel. The light control unit 210 changes a light transmittance for each pixel. The light sources 220a to 220n are, for example, Light Emitting Diodes (LEDs) for supplying light to the light control unit 210, and are arranged in a line along one of sides of the light control unit 210 illustrated in FIG. 3. In this case, one of sides of the light control unit 210 is a horizontal lower side of the light control unit 210 illustrated in FIG. 3. By arranging the light sources 220a to 220n in a line, it is possible to obtain a substantially uniform luminance level on the entire surface of the light control unit 210 while a plurality of light sources emit light. The number of the light sources 220 and a method of arranging the light sources 220 may be changed as appropriate. When the number of the light sources 220 is 12, the light sources 220a to 2201 are present.

The storage unit 250 stores light emission pattern data 250a about a light emission pattern formed on the light control unit 210 when the light sources 220 emit light of various intensities to the light control unit 210. For example, the storage unit 250 stores information about the luminance level of light supplied to each point on the light control unit 210 when one of the light sources 220 emits light having an intensity of 100% as the light emission pattern data 250a for the light source 220.

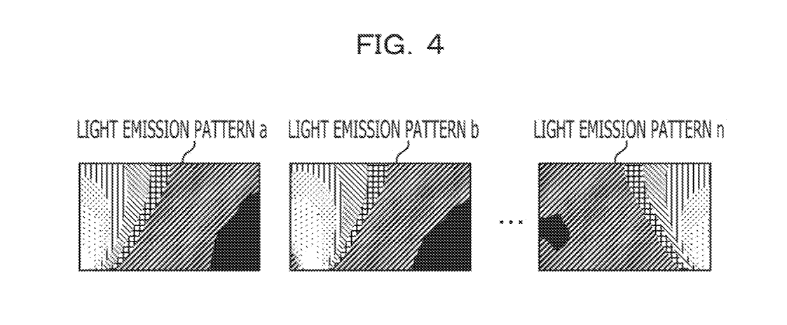

The light emission pattern is indicated by a light distribution formed on the light control unit 210 when one of the light sources 220 emits light to the light control unit 210 at a certain light emission intensity. FIG. 4 is a diagram illustrating examples of light emission patterns formed by light sources.

For example, when the light source 220a emits light to the light control unit 210, a light emission pattern a illustrated in FIG. 4 is formed. The light emission pattern a represents the distribution of light supplied from the light source 220a to the light control unit 210. The highest brightness level is obtained at the lower left corner of the light emission pattern a of the light source 220a which is the nearest to the light source 220a, and the lowest brightness level is obtained at the lower right corner of the light emission pattern a. When the light emission pattern a is represented by a curve, a curve having a sharply curved portion corresponding to the lower left corner of the light emission pattern a is obtained. The light emission pattern a varies in accordance with the distance between the light source 220a and the light control unit 210 in a direction perpendicular to the direction in which the light sources 220 are arranged. The shorter the distance between them, the sharper the light emission pattern. When the distance between them is increased, a light emission pattern is represented by a gentle curve. The light emission pattern represented by a gentle curve is referred to as, for example, a broad light emission pattern.

A light emission pattern b illustrated in FIG. 4 is formed when the light source 220b emits light to the light control unit 210. The light emission pattern b represents the distribution of light supplied from the light source 220b to the light control unit 210. The highest brightness level is obtained in a portion that is slightly apart from the lower left corner of the light emission pattern b of the light source 220b and is the nearest to the light source 220b, and the lowest brightness level is obtained at the lower right corner of the light emission pattern b. When the light emission pattern b is represented by a curve, a curve having a sharply curved portion corresponding to the position of the light source 220b is obtained. The distance between the light source 220b and the light control unit 210 is increased, a broad light emission pattern represented by a gentle curve is obtained.

A light emission pattern n illustrated in FIG. 4 is formed when the light source 220n emits light to the light control unit 210. The light emission pattern n represents the distribution of light supplied from the light source 220n to the light control unit 210. The highest brightness level is obtained at the lower right corner of the light emission pattern n of the light source 220n which is the nearest to the light source 220n, and the lowest brightness level is obtained at a portion slightly above the lower left corner of the light emission pattern n. When the light emission pattern n is represented by a curve, a curve having a sharply curved portion corresponding to the position of the light source 220n is obtained. The distance between the light source 220n and the light control unit 210 is increased, a broad light emission pattern represented by a gentle curve is obtained.

The storage unit 250 stores the light emission pattern data 250a used for creation of a model obtained by representing the light emission pattern a or b in the form of curve. For example, a light emission pattern of light supplied to the light control unit 210 from the direction perpendicular to the direction in which the light sources 220 are arranged when each of the light sources 220 emits light at a certain light emission intensity is a light emission pattern obtained by superimposing light emission patterns of the light sources 220. Accordingly, the storage unit 250 stores data obtained by adding intensities of light supplied from the light sources 220 at each point on the light control unit 210 as the light emission pattern data 250a.

The storage unit 250 may store a value normalized at each point on the light control unit 210 as the light emission pattern data 250a. For example, the storage unit 250 stores the light emission pattern data 250a on condition that a value obtained when all of the light sources 220, e.g., twelve light sources, emit light at a light emission intensity of 100% is 1. As a result, a subsequent processing load is reduced.

Referring back to FIG. 3, the drivers 230a to 230n drive the light sources 220a to 220n, respectively, in accordance with a control amount transmitted from the display control device 240. In FIG. 3, the driver 230 is disposed for each of the light sources 220. However, the driver 230 may be disposed for the light sources 220.

The display control device 240 controls the light control unit 210 and the drivers 230a to 230n, and includes a frame memory 241, a generation unit 242, a computation unit 243, a light emission intensity control unit 244, an image correction unit 245, and a transmittance control unit 246.

The frame memory 241 receives a display target image and stores it. For example, the size of an input image is 720 (height)×480 (width).

The generation unit 242 reads out the input image stored in the frame memory 241, and generates a reduced image of the read input image so as to reduce a time of processing performed by the computation unit 243 to be described later.

The generation unit 242 refers to a Red (R) value, a Green (G) value, and a Blue (B) value set for each pixel in the input image so as to obtain the maximum value among them, and sets the maximum value as a value of the pixel. For example, when the R value of 250, the G value of 100, and the B value of 50 are set for a first pixel, the generation unit 242 sets the maximum value among them, e.g., the value of 250, as the pixel value of the first pixel. Thus, the generation unit 242 sets a single pixel value for each pixel in an input image.

Subsequently, for example, the generation unit 242 reads a single line every eight lines in an input image of 720 (height)×480 (width). For example, the generation unit 242 generates a reduced image of 90×60 by performing a thinning-out processing for reading out a single pixel every eight pixels. The above-described pixel value is set for each pixel in the reduced image. The generation unit 242 may generate a reduced image using another method such as a bi-linear method, for example.

An acquisition unit 260 measures an ambient illumination level of a display apparatus and outputs the ambient illumination level to the computation unit 243. The acquisition unit 260 includes, for example, an illumination sensor.

The computation unit 243 adjusts a light emission intensity of each of the light sources 220 on the basis of the light emission pattern data 250a stored in the storage unit 250 and data of a reduced image.

The computation unit 243 sets an initial value of the light emission intensity of each of the light sources 220 for the input image that has been input as a display target image. For example, the computation unit 243 sets the light emission intensity of each of the light sources 220 which has been determined for the last displayed input image as an initial value of the light emission intensity of the light source 220 for the next input image. The last image and the next image are generally similar to each other. Accordingly, by setting the last adjustment result as an initial value, the computation unit 243 may reduce a time required for adjusting the light emission intensity of each light source. Furthermore, since it is expected that the last adjustment result and the next adjustment result are similar to each other, it is not necessary to perform different adjustment operations for input images. It is therefore possible to reduce or substantially prevent the occurrence of flicker or the like on an image displayed on the light control unit 210. When an input image is the first image, a light emission intensity set in advance is set as an initial value. For example, a light emission intensity of 100% is set as an initial value.

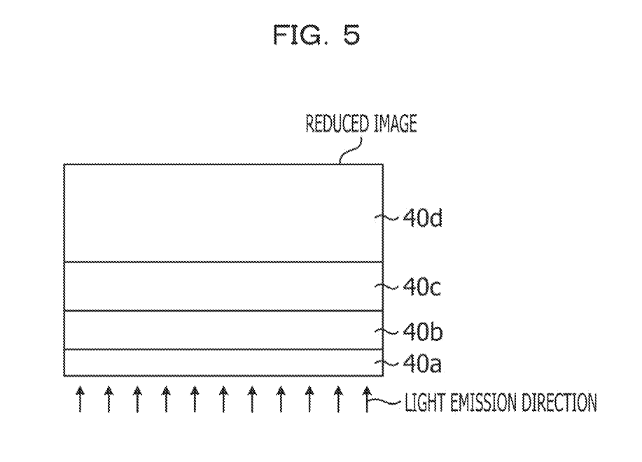

Subsequently, the computation unit 243 divides the reduced image generated by the generation unit 242 into areas each including a plurality of straight lines perpendicular to the direction of light emitted from each of the light sources 220. It is possible to reduce the number of times of calculation by dividing the reduced image into a plurality of areas and performing processing for setting a light emission intensity of each light source for each of the areas as will be described later. However, the reduced image may not be divided into areas and the processing for setting a light emission intensity may be performed for each line. For example, as illustrated in FIG. 5, the computation unit 243 divides the reduced image into areas 40a, 40b, 40c, and 40d. The farther from the light sources 220, the larger the area. FIG. 5 is a diagram illustrating an example case in which a reduced image is divided into areas. The direction of light emitted from the light sources 220 is a direction in which light emitted from the light sources 220 enters the light control unit 210 when an input image corresponding to a reduced image is displayed on the light control unit 210.

Subsequently, the computation unit 243 generates line information for each of the areas into which the reduced image is divided. The computation unit 243 compares pixel values of a plurality of pixels arranged in a column perpendicular to a direction in which the light sources 220 are arranged. The computation unit 243 selects the maximum pixel value from among the pixel values and sets the selected maximum pixel value as a pixel value for the column. The computation unit 243 generates line information by setting a pixel value for all columns included in each area. When the reduced image is not divided, pixel values of pixels arranged in each line are used as the line information.

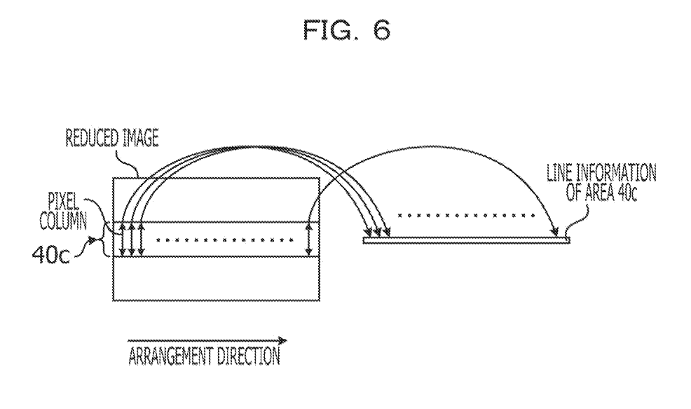

FIG. 6 is a diagram describing an example method of generating line information. FIG. 6 illustrates a case in which line information is generated for the area 40c in a reduced image. As illustrated in FIG. 6, for example, the computation unit 243 compares pixel values of pixels in each column of the area 40c perpendicular to a direction in which the light sources 220 are arranged. The computation unit 243 selects the maximum pixel value from among the pixel values and sets the selected maximum pixel value as a pixel value for the column. The computation unit 243 generates line information for the area 40c by setting a pixel value for all columns included in the area 40c.

Subsequently, the computation unit 243 acquires line information for the area 40a nearest to the light sources 220. For example, when the reduced image has the size of 90×60, the acquired line information includes pixel values of 60 pixels.

The shorter the distance between each of the light sources 220 and the light control unit 210, the sharper the light emission pattern of the light source 220. The greater the distance between each of the light sources 220 and the light control unit 210, the broader the light emission pattern of the light source 220. Even if the light emission intensity of one of the light sources 220 is reduced when the light emission patterns of the light sources 220 are broad, a combined light emission pattern of the light sources 220 is not significantly changed. On the other hand, if the light emission intensity of one of the light sources 220 is reduced when the light emission patterns of the light sources 220 are sharp, the combined light emission pattern of the light sources 220 is significantly changed. By processing an image starting from the bottom corresponding to a sharp portion of a light emission pattern, it is possible to process the image starting from a portion that is significantly affected by adjustment of a light emission intensity.

The computation unit 243 converts the pixel values of pixels included in the acquired line information into luminance level equivalent values, and corrects the luminance level equivalent values in accordance with the illumination level received from the acquisition unit 260.

For example, the computation unit 243 sets a variable W representing a reduction rate used for reducing the luminance level of a display target image in accordance with an illumination level and corrects the luminance level equivalent value with the variable W. When the value of the illumination level is small, the computation unit 243 sets the variable W capable of reducing the luminance level of a display target image. The computation unit 243 calculates a luminance level equivalent value with equation (1). When the value of the illumination level is small, an environment is dark.

Luminance level equivalent value=(pixel value/maximum pixel value)̂2.2 (1)

The premise of Equation 1 is the proportional relationship of luminance level ∝ (pixel valuê2.2). For example, the maximum pixel value is 255 in the case of a 8-bit image.

The computation unit 243 substitutes the luminance level equivalent value obtained from equation (1) into equation (2) to calculate a corrected luminance level equivalent value. Thus, a corrected luminance level equivalent value may be obtained by reducing a luminance level equivalent value with the reduction rate W.

Corrected luminance level equivalent value=luminance level equivalent value×W (2)

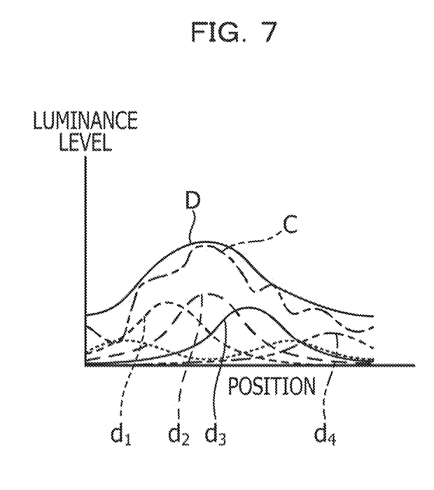

The computation unit 243 scans the corrected luminance level equivalent values in the direction in which the light sources 220 are arranged so as to calculate a luminance distribution pattern. FIG. 7 is a diagram illustrating an example comparison according to the second embodiment between a luminance distribution pattern and a combined light emission pattern. The computation unit 243 acquires corrected luminance level equivalent values by performing scanning in the direction in which the light sources 220 are arranged, and calculates a luminance distribution pattern represented by C in FIG. 7 by connecting the corrected luminance level equivalent values with a curve.

The computation unit 243 calculates a combined light emission pattern by reading out the light emission pattern data 250a stored in the storage unit 250 and combining the light emission patterns of the light sources 220. The computation unit 243 extracts the light emission pattern data obtained when each of the light sources 220 emits light at a certain light emission intensity from the light emission pattern data 250a stored in the storage unit 250. For example, as illustrated in FIG. 7, the computation unit 243 calculates light emission patterns d₁, d₂, d₃, d₄, for example, at a position similar to that of a processing target area in a direction perpendicular to the direction in which the light sources 220 are arranged on the basis of the pieces of light emission pattern data of the light sources 220. The computation unit 243 performs weighted addition of luminance levels included in the light emission patterns of the light sources 220 at each point on the light control unit 210. The computation unit 243 calculates a combined light emission pattern D at a position similar to that of the processing target area by generating a curve connecting results of the weighted additions.

When the initial value of the light emission intensity of each light source is set to 100%, the computation unit 243 reads out the light emission pattern data 250a obtained when the light emission intensity of each of the light sources 220 is 100% from the storage unit 250. The computation unit 243 calculates a combined light emission pattern at a position similar to that of a processing target area.

The computation unit 243 converts the calculated combined light emission pattern into a combined light emission pattern for, for example, sixty pixels on the basis of a size set for the line information. For example, as illustrated in FIG. 7, the computation unit 243 compares a luminance distribution pattern and a combined light emission pattern with each other. Here, the combined light emission pattern for sixty pixels is obtained by performing conversion from a combined light emission pattern into the combined light emission pattern for sixty pixels at each of points on the light control unit 210 corresponding to the line information.

When the combined light emission pattern is above the luminance distribution pattern, the computation unit 243 performs reduction rate adjustment processing for searching for one of the light sources 220 whose light emission intensity may be most significantly reduced.

The reduction rate adjustment processing is performed for line information of an area that is at the bottom of the reduced image and is the nearest to the light sources 220. Thus, when a reduction rate is adjusted with line information generated from an area that is not at the bottom of the reduced image, the amount of light may be insufficient to display an image in an area in a display target image corresponding to an area at the bottom of the reduced image.

On the other hand, when the combined light emission pattern has a portion below the luminance distribution pattern, the computation unit 243 performs increase rate adjustment processing for increasing the light emission intensity of a light source. The reduction rate adjustment processing and the increase rate adjustment processing will be described below in this order.

[Reduction Rate Adjustment Processing]

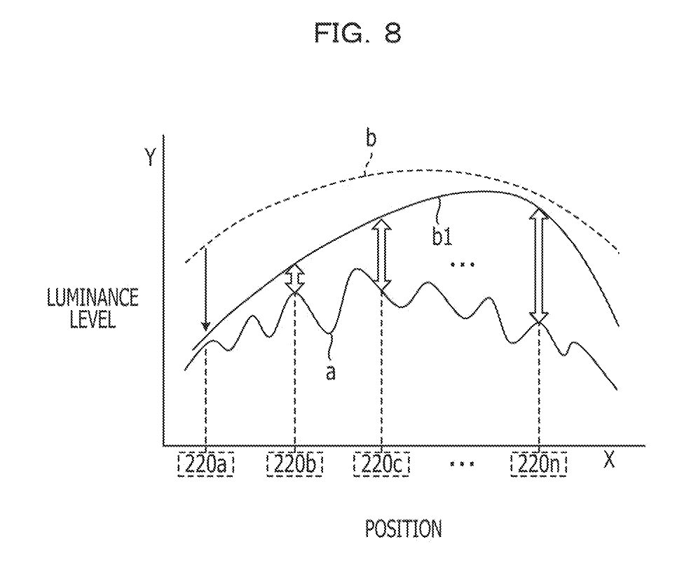

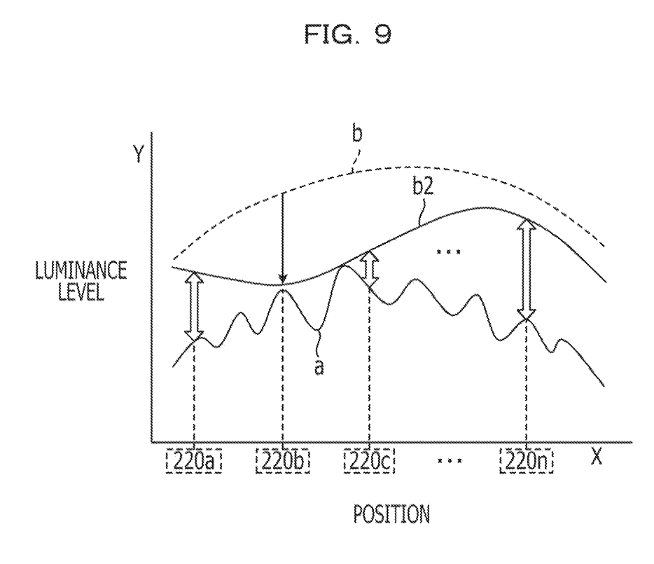

FIGS. 8 and 9 are diagrams describing reduction rate adjustment processing according to the second embodiment. Reduction rate adjustment processing will be described with reference to FIGS. 8 and 9. As illustrated in FIG. 8, the computation unit 243 selects the light source 220a and calculates the maximum reduction rate at which the light emission intensity of the light source 220a may be reduced in the range in which a combined light emission pattern is above a luminance distribution pattern.

For example, the computation unit 243 calculates a combined light emission pattern when the light emission intensity of the light source 220a is reduced by 10% and compares the calculated combined light emission pattern with a luminance distribution pattern. When there is a margin between the combined light emission pattern and the luminance distribution pattern, the computation unit 243 calculates a combined light emission pattern when the light emission intensity of the light source 220a is reduced by 5% and compares the calculated combined light emission pattern with the luminance distribution pattern. Here, when there is a margin between a combined light emission pattern and a luminance distribution pattern, for example, the combined light emission pattern is above the luminance distribution pattern and the light emission intensity of the light source 220a may be reduced. The computation unit 243 calculates the maximum reduction rate at which the light emission intensity of the light source 220a may be reduced in the range in which the combined light emission pattern is above the luminance distribution pattern.

When the light emission intensity of the light source 220a may not be adjusted, the computation unit 243 does not calculate a margin. The computation unit 243 does not calculate the margin because the combined light emission pattern may be partially below the luminance distribution pattern when the light emission intensity of the light source 220a is reduced. When the light emission intensity of the light source 220a may not be adjusted, the computation unit 243 calculates the maximum reduction rate of the light emission intensity of the light source 220b. The above-described process is repeated. The margin calculated when the light emission intensity of one of the light sources 220 is reduced indicates the amount of reducible light emission intensity of the other ones of the light sources 220.

On the other hand, a case where the light emission intensity of the light source 220a may be adjusted will be described. In this case, the maximum reduction rate of the light emission intensity of the light source 220a may be calculated. As illustrated in FIG. 8, the computation unit 243 creates a combined light emission pattern b1 after reducing the light emission intensity of the light source 220a at the calculated maximum reduction rate. Subsequently, the computation unit 243 compares the combined light emission pattern b1 illustrated in FIG. 8 and a luminance distribution pattern a illustrated in FIG. 8 with each other so as to calculate a margin that is a value representing the amount of reducible light emission intensity of the light sources 220b to 220n.

The computation unit 243 may set an upper limit of, for example, 20% to the amount of reduction in a light emission intensity. Thus, when the amount of light is significantly reduced, the difference in a brightness level between the last displayed image and the next displayed image becomes large and noise such as flicker may occur, for example.

For example, as represented by double-headed arrows illustrated in FIG. 8, the computation unit 243 calculates the difference between the combined light emission pattern b1 and the luminance distribution pattern a in areas corresponding to the positions of the light sources 220b to 220n. For example, the computation unit 243 calculates the difference between a luminance level obtained from a combined light emission pattern and a luminance level required by a luminance distribution pattern in areas corresponding to the positions of the light sources 220b to 220n. The computation unit 243 calculates a margin by adding reduction rates calculated for the light sources 220.

After the margin has been calculated, processing similar to that performed for the light source 220a is performed for the light source 220b. For example, as illustrated in FIG. 9, the computation unit 243 calculates the maximum reduction rate at which the light emission intensity of the light source 220b may be reduced in the range in which the combined light emission pattern b is above the luminance distribution pattern a.

When the light emission intensity of the light source 220b may not be adjusted, the computation unit 243 does not calculate the margin. The computation unit 243 calculates the maximum reduction rate of the light emission intensity of the light source 220c.

When the light emission intensity of the light source 220b may be adjusted, as illustrated in FIG. 9, the computation unit 243 creates a combined light emission pattern b2 after reducing the light emission intensity of the light source 220b at the calculated maximum reduction rate. Subsequently, the computation unit 243 compares the combined light emission pattern b2 and the luminance distribution pattern a with each other so as to calculate a margin that is a value representing the amount of reducible light emission intensity of the light sources 220.

More specifically, the computation unit 243 calculates the difference between the combined light emission pattern b2 and the luminance distribution pattern a in areas corresponding to the positions of the light source 220a and the light sources 220c to 220n. For example, the computation unit 243 calculates the difference between a luminance level obtained from the combined light emission pattern b2 and a luminance level required by the luminance distribution pattern a in areas corresponding to the positions of the light source 220a and the light sources 220c to 220n. For example, the differences are represented by double-headed arrows illustrated in FIG. 9. The computation unit 243 calculates a margin by adding the differences calculated in the areas corresponding to the positions of the light sources 220.

The computation unit 243 performs the calculation of a margin, which has been performed at the time of reduction of the light emission intensity of the light sources 220a and 220b, for the light sources 220c to 220n.

The computation unit 243 selects one of the light sources 220a to 220n having the maximum margin, temporarily determines the light emission intensity of the selected one of the light sources 220a to 220n in accordance with the calculated reduction rate, and excludes the selected one of the light sources 220a to 220n whose light emission intensity has been temporarily determined from selection candidates. The computation unit 243 repeatedly performs the above-described process for remaining ones of the light sources 220 assuming that one of the light sources 220 that has been excluded from selection candidates emits light at the temporarily determined light emission intensity. Thus, the computation unit 243 reduces a light emission intensity as much as possible by selecting one of the light sources 220 having the maximum margin.

On the other hand, when there is no light source 220 for which a margin may be calculated, e.g., there is no light source 220 whose light emission intensity may be reduced, the computation unit 243 terminates the reduction rate adjustment processing.

For example, it is assumed that the margin calculated when the light emission intensity of the light source 220a is reduced at the maximum reduction rate is the maximum as illustrated in FIG. 8. In this case, the computation unit 243 selects the light source 220a. After selecting the light source 220a, the computation unit 243 temporarily determines the light emission intensity of the light source 220a in accordance with the maximum reduction rate. For example, when the light emission intensity of the light source 220a may be reduced by 19% in accordance with the maximum reduction rate, the computation unit 243 temporarily sets the light emission intensity of the light source 220a to 19%.

After excluding the light source 220a whose light emission intensity has been temporarily determined from selection candidates, the computation unit 243 performs the above-described process for the light sources 220b to 220n assuming that the light source 220a emits light at the light emission intensity of −19%. For example, the computation unit 243 selects one of the light sources 220 that are selection candidates and performs the above-described process for the selected one of the light sources 220. On the other hand, there is no light source 220 that is a selection candidate, the computation unit 243 terminates the reduction rate adjustment processing.

For example, it is assumed that the margin calculated when the light emission intensity of the light source 220b is reduced at the maximum reduction rate is the maximum among the light sources 220b to 220n that are selection candidates. In this case, the computation unit 243 selects the light source 220b. After selecting the light source 220b, the computation unit 243 temporarily determines the light emission intensity of the light source 220b in accordance with the maximum reduction rate. For example, when the light emission intensity of the light source 220b may be reduced by 15% in accordance with the maximum reduction rate, the computation unit 243 temporarily sets the light emission intensity of the light source 220b to 15%.

In order to reduce or substantially prevent the variations in luminance level, adjustment processing may be performed so that the difference between the light emission intensity reduction rates for the adjacent light sources 220 is substantially equal to or lower than a certain value.

After excluding the light source 220b whose light emission intensity has been temporarily determined from selection candidates, the computation unit 243 performs the above-described process for the light sources 220c to 220n assuming that the light source 220b emits light at the light emission intensity of −15%.

[Increase Rate Adjustment Processing]

Next, increase rate adjustment processing will be described. The computation unit 243 finds a portion to which the smallest amount of light is supplied by comparing a combined light emission pattern and a luminance distribution pattern with each other. The computation unit 243 selects one of the light sources 220 nearest to the portion as an adjustment target light source.

The computation unit 243 temporarily sets the light emission intensity of the selected one of the light sources 220 to a certain light intensity. For example, the computation unit 243 temporarily sets the light emission intensity of the selected one of the light sources 220 to a light emission intensity that is 5% higher than a current light intensity. The computation unit 243 may set an upper limit of 20% to the amount of increase in light emission intensity.

After temporarily setting the light emission intensity of the selected one of the light sources 220 to a certain light emission intensity, the computation unit 243 recalculates a combined light emission pattern.

The computation unit 243 compares the recalculated combined light emission pattern and the luminance distribution pattern with each other so as to determine whether the light insufficiency problem has been overcome in the portion. When the light insufficiency problem has been overcome, the computation unit 243 finds another portion to which the smallest amount of light is supplied. When there is no portion with insufficient light, the computation unit 243 terminates the increase rate adjustment processing.

On the other hand, when there is another portion with insufficient light, the computation unit 243 determines whether there is an adjustable one of the light sources 220. When there is no adjustable light source 220, the computation unit 243 terminates the increase rate adjustment processing.

When the light insufficiency problem has not been overcome, the computation unit 243 determines whether the amount of increase in light emission intensity reaches the upper limit. For example, the upper limit to the amount of increase in light emission intensity is set to 20%. When the amount of increase in light emission intensity does not reach the upper limit, the computation unit 243 temporarily determines the higher light emission intensity of one of the light sources 220 which has been selected as an adjustment target. Subsequently, as described previously, the computation unit 243 recalculates a combined light emission pattern and determines whether the light insufficiency problem has been overcome.

On the other hand, when the amount of increase in light emission intensity reaches the upper limit, the computation unit 243 selects one of the light sources 220 which is adjacent to the adjustment target as a new adjustment target. For example, when light sources A to E are arranged in this order and the light source C is selected as an adjustment target, a new adjustment target is selected in the order of the light sources B→D→A→E or D→B→E→A.

The computation unit 243 determines whether a new adjustment target that is one of the light sources 220 has yet to be selected and is selectable. When the new adjustment target is selectable, the computation unit 243 performs a process similar to the above-described process upon the selected new adjustment target. Thus, after increasing the light emission intensity of one of the light sources 220 that has been selected as a new adjustment target, the computation unit 243 compares a light emission intensity and a luminance distribution pattern with each other and determines whether a light insufficiency problem has been overcome in a corresponding portion.

On the other hand, when the new adjustment target that is one of the light sources 220 is not selectable, the computation unit 243 finds another portion to which the smallest amount of light is supplied as described previously.

When the reduction rate adjustment processing or the increase rate adjustment processing has been performed for a single piece of line information, the computation unit 243 determines whether the reduction rate adjustment processing or the increase rate adjustment processing has been performed for all pieces of line information. When the reduction rate adjustment processing or the increase rate adjustment processing has yet to be performed for all pieces of line information, the computation unit 243 performs the reduction rate adjustment processing or the increase rate adjustment processing for line information for which the reduction rate adjustment processing or the increase rate adjustment processing has yet to be performed.

On the other hand, when the reduction rate adjustment processing or the increase rate adjustment processing has been performed for all pieces of line information, the computation unit 243 adjusts the light emission intensity of each of the light sources 220. The computation unit 243 sets the light emission intensity of each of the light sources 220 temporarily determined in the reduction rate adjustment processing or the increase rate adjustment processing as the final light emission intensity and outputs an adjustment instruction to adjust the light emission intensity of an adjustment target to the light emission intensity control unit 244.

For example, when the light emission intensity of the light source 220a is temporarily set to −19%, the computation unit 243 sets a light emission intensity obtained by reducing the light emission intensity for the last display target image by 19% as the final light emission intensity of the light source 220a. Subsequently, the computation unit 243 outputs an adjustment instruction to reduce the light emission intensity of the light source 220a by 19% to the light emission intensity control unit 244.

The computation unit 243 outputs a correction instruction to correct values of pixels of a display target image to the image correction unit 245 in synchronization with the adjustment of light emission intensities of the light sources 220.

In order to reduce or substantially prevent the variations in luminance level, adjustment processing may be performed so that the difference between the amounts of increase in light emission intensity of adjacent ones of the light sources 220 is substantially equal to or lower than a certain value.

The light emission intensity control unit 244 performs adjustment processing so that each of the light sources 220 emits light at a light emission intensity determined by the computation unit 243. For example, in response to a light emission intensity adjustment instruction transmitted from the computation unit 243, the light emission intensity control unit 244 outputs to the drivers 230 the amount of control based on a reduction rate determined in the reduction rate adjustment processing or an increase rate determined in the increase rate adjustment processing.

The image correction unit 245 corrects each pixel of an input image in accordance with the change in the amount of light supplied to a corresponding pixel of the light control unit 210 which is caused by adjustment performed by the computation unit 243. For example, the image correction unit 245 corrects an image with the following equation (3).

Corrected pixel value=uncorrected pixel value×(1/W)̂(1/2.2) (3)

A variable W in equation (3) is the same as the variable W in equation (2).

The transmittance control unit 246 controls the transmittance of each pixel of the light control unit 210 in accordance with the value of a corresponding pixel of an input image which has been corrected by the image correction unit 245.

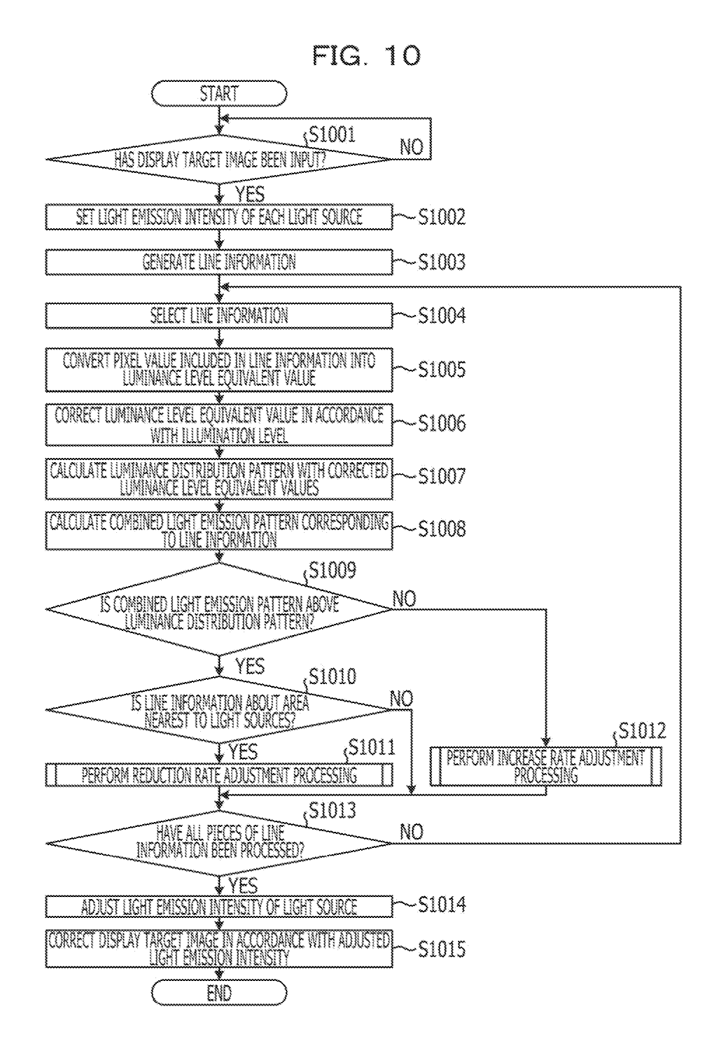

FIGS. 10 to 12 are diagrams illustrating a process performed by a display apparatus according to the second embodiment. First, the entire process performed by a display apparatus will be described with reference to FIG. 10.

[Entire Process]

As illustrated in FIG. 10, when a display target image has been input (Yes in operation S1001), the computation unit 243 sets initial values of light emission intensities of the light sources 220 (operation S1002). The computation unit 243 divides a reduced image generated by the generation unit 242 into a plurality of areas and generates line information for each of the areas (operation S1003).

The computation unit 243 selects one of the generated pieces of line information (operation S1004). The computation unit 243 selects the line information of the area 40a that is the nearest to the light sources 220 and is at the bottom of the reduced image.

After selection of line information, the computation unit 243 converts pixel values included in the selected line information into luminance level equivalent values (operation S1005). At that time, equation 1 is used. The computation unit 243 calculates corrected luminance level equivalent values in accordance with an illumination level input from the acquisition unit 260 (operation S1006). At that time, equation (2) is used. When the acquisition unit 260 receives a request to reduce the luminance level of a displayed image from the viewer of the display apparatus 1, the computation unit 243 may correct the luminance level equivalent values. For example, when a viewer presses an energy saving mode button disposed in the display apparatus 1, the computation unit 243 calculates corrected luminance level equivalent values. At that time, the acquisition unit 260 may receive a request including luminance level reduction information about the amount of reduction in luminance level (%) from the viewer. The computation unit 243 calculates corrected luminance level equivalent values by multiplying luminance level equivalent values by the luminance level reduction information.

After calculating the corrected luminance level equivalent values, the computation unit 243 scans the corrected luminance level equivalent values in a direction in which the light sources 220 are arranged so as to calculate a luminance distribution pattern (operation S1007). After calculating the luminance distribution pattern, the computation unit 243 reads out the light emission pattern data 250a stored in the storage unit 250. The computation unit 243 calculates a combined light emission pattern in accordance with the size of the line information (operation S1008).

The computation unit 243 compares the luminance distribution pattern based on the line information and the combined light emission pattern corresponding to the line information with each other. The computation unit 243 determines whether the combined light emission pattern is above the luminance distribution pattern (operation S1009). For example, the computation unit 243 determines whether the amount of light is sufficient to display an image.

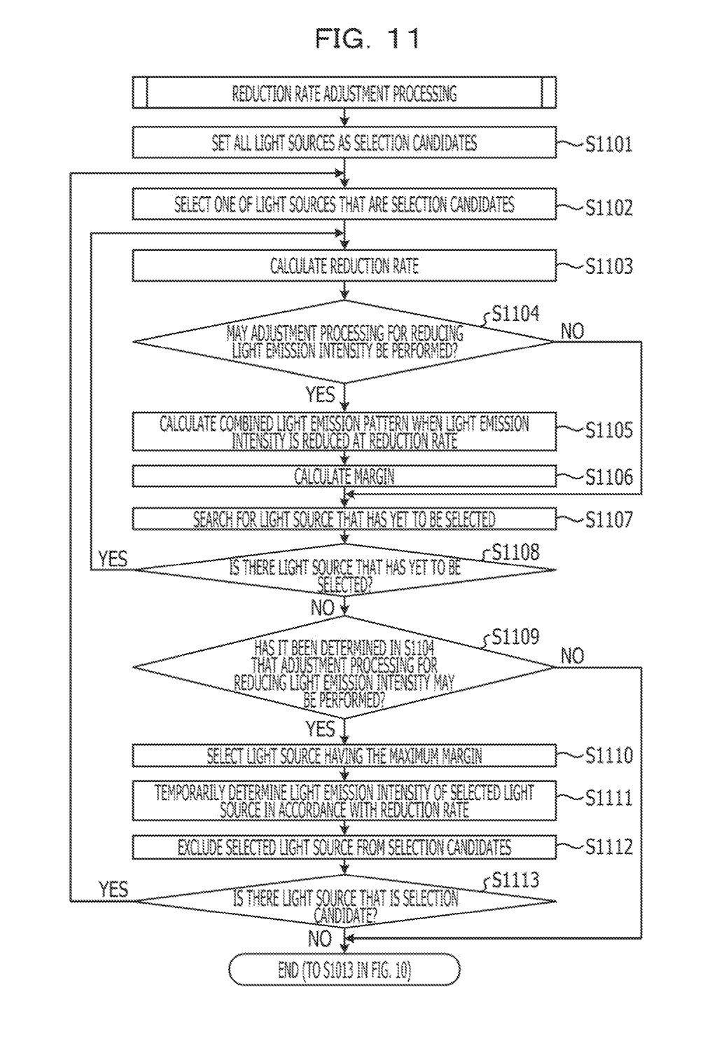

When the combined light emission pattern is above the luminance distribution pattern (Yes in operation S1009), the computation unit 243 determines whether the line information is information for an area including the bottom line (operation S1010). When the line information is information for an area including the bottom line (Yes in operation S1010), the computation unit 243 performs reduction rate adjustment processing (operation S1011). The reduction rate adjustment processing will be described later with reference to FIG. 11.

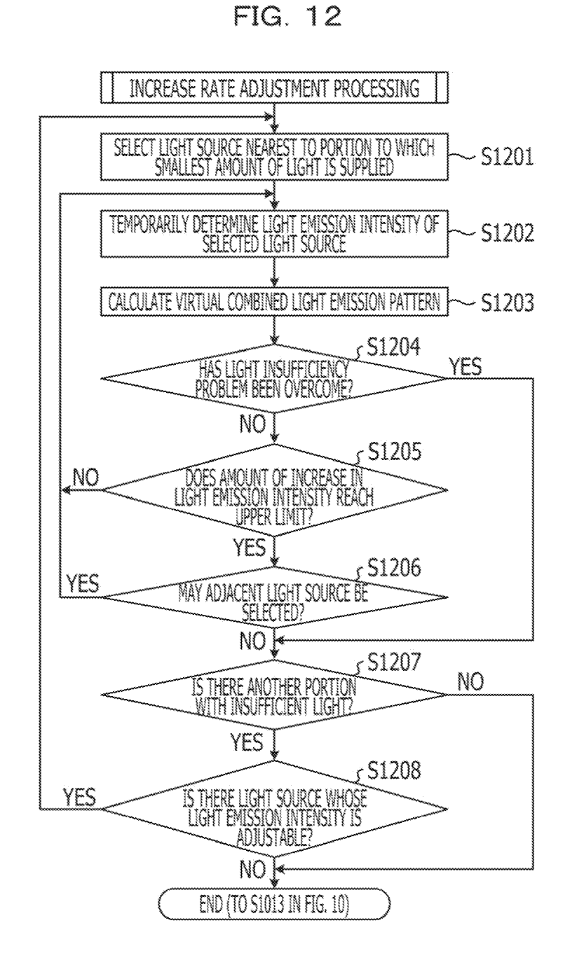

When the combined light emission pattern is not above the luminance distribution pattern (No in operation S1009), the computation unit 243 performs increase rate adjustment processing (operation S1012). The increase rate adjustment processing will be described later with reference to FIG. 12.

After performing the reduction rate adjustment processing or the increase rate adjustment processing, the computation unit 243 determines whether processing has been performed for all pieces of line information (operation S1013). When processing has yet to be performed for all pieces of line information (No in operation S1013), the process from operation S1004 to operation S1012 is performed.

On the other hand, when processing has been performed for all pieces of line information (Yes in operation S1013), the computation unit 243 outputs an adjustment instruction to the light emission intensity control unit 244 so that a light emission intensity determined in the processing is set. The computation unit 243 outputs a correction instruction to adjust values of pixels of a display target image to the image correction unit 245.

Upon receiving the light emission intensity adjustment instruction from the computation unit 243, the light emission intensity control unit 244 adjusts the light emission intensity of each light source (operation S1014). Upon receiving the pixel value correction instruction from the computation unit 243, the image correction unit 245 corrects the value of each pixel of the display target image in accordance with the change in the amount of light supplied to the light control unit 210 which is caused by the adjustment of a light emission intensity (operation S1015).

When the line information is not information for an area including the bottom line (No in operation S1010), the process proceeds to operation S1013.

Next, the reduction rate adjustment processing illustrated in FIG. 10 will be described with reference to FIG. 11. As illustrated in FIG. 11, all of the light sources 220 are set as selection candidates (operation S1101). The computation unit 243 selects one of the light sources 220 that are selection candidates (operation S1102).

After selecting one of the light sources 220, the computation unit 243 calculates the maximum reduction rate of the light emission intensity of the selected light source 220 in the range in which the insufficiency of light does not occur (operation S1103).

The computation unit 243 determines whether adjustment processing for reducing the light emission intensity of the selected light source 220 may be performed on the basis of a result of the calculation of the maximum reduction rate (operation S1104). When the adjustment processing may be performed (Yes in operation S1104), the computation unit 243 recalculates a combined light emission pattern when the light emission intensity of the selected light source 220 is reduced at the calculated maximum reduction rate (operation S1105).

The computation unit 243 compares the recalculated combined light emission pattern and the luminance distribution pattern with each other. The computation unit 243 calculates a margin (operation S1106). The computation unit 243 searches for the light source 220 that has yet to be selected (operation S1107). The computation unit 243 determines whether there is the light source 220 that has yet to be selected (operation S1108). When there is the light source 220 that has yet to be selected (Yes in operation S1108), the computation unit 243 selects one of the light sources 220 which has yet to be selected and performs the process from operation S1103 to operation S1108 for the selected one of the light sources 220.

When the adjustment processing for reducing a light emission intensity may not be performed (No in operation S1104), the process proceeds to operation S1107.

When the light source 220 that has yet to be selected is not present (No in operation S1108), the computation unit 243 determines whether the light source 220 for which the adjustment processing for reducing a light emission intensity may be performed has been present in operation S1104 (operation S1109). When it is determined that the light source 220 for which the adjustment processing for reducing a light emission intensity may be performed has not been present in operation S1104 (No in operation S1109), the computation unit 243 terminates the reduction rate adjustment processing. The process proceeds to operation S1013.

On the other hand, when it is determined that the light source 220 for which the adjustment processing for reducing a light emission intensity may be performed has been present in operation S1104 (Yes in operation S1109), the computation unit 243 performs the following process. The computation unit 243 selects the light source 220 having the maximum margin from among the light sources 220 for which the adjustment processing for reducing a light emission intensity may be performed and sets the selected light source 220 as a light emission intensity adjustment target (operation S1110). The computation unit 243 temporarily determines the light emission intensity of the light source 220 selected as a light emission intensity adjustment target in accordance with the calculated reduction rate (operation S1111).

After outputting a light emission intensity adjustment instruction, the computation unit 243 excludes the light source 220 for which light emission intensity adjustment has been performed from the selection candidates (operation S1112). The computation unit 243 determines whether there is the light source 220 that is the selection candidate (operation S1113). When there is the light source 220 that is the selection candidate (Yes in operation S1113), the process from operation S1102 to operation S1112 is performed. On the other hand, when there is no light source 220 that is the selection candidate (No in operation S1113), the computation unit 243 terminates the reduction rate adjustment processing. The process proceeds to operation S1013.

The increase rate adjustment processing illustrated in FIG. 10 will be described with reference to FIG. 12. As illustrated in FIG. 12, the computation unit 243 compares a combined light emission pattern and a luminance distribution pattern with each other so as to extract a portion to which the smallest amount of light is supplied. The computation unit 243 selects one of the light sources 220 which is the nearest to the extracted portion as an adjustment target light source (operation S1201).

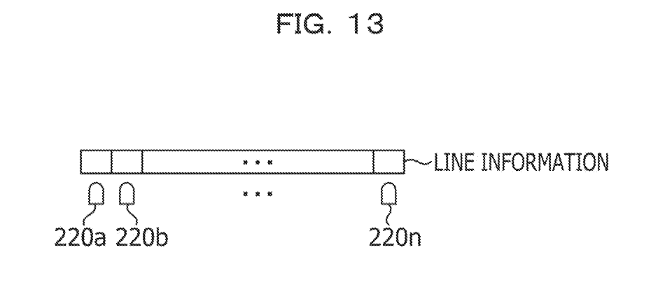

For example, as illustrated in FIG. 13, the computation unit 243 may select one of the light sources 220 which is the nearest to a portion with insufficient light by dividing an adjustment target area into areas the number of which is the same as that of the light sources 220. FIG. 13 is a diagram illustrating example area division performed to select a light source nearest to a portion to which the smallest amount of light is supplied.

The computation unit 243 temporarily sets the light emission intensity of one of the light sources 220 which has been selected as an adjustment target to a certain light emission intensity (operation S1202). The computation unit 243 recalculates a combined light emission pattern obtained when the light emission intensity of the selected one of the light sources 220 is temporarily set to a certain intensity (operation S1203).

After recalculating a combined light emission pattern, the computation unit 243 compares the recalculated combined light emission pattern and the luminance distribution pattern with each other so as to determine whether a light insufficiency problem has been overcome in the portion (operation S1204). When the light insufficiency problem has not been overcome (No in operation S1204), the computation unit 243 determines whether the amount of increase in light emission intensity reaches an upper limit (operation S1205). When the amount of increase in light emission intensity does not reach an upper limit (No in operation S1205), the process returns to operation S1202. The computation unit 243 temporarily determines the further increased light emission intensity of one of the light sources 220 which has been selected as an adjustment target. The computation unit 243 performs the process from operation S1203 to operation S1204.

On the other hand, when the amount of increase in light emission intensity reaches the upper limit (Yes in operation S1205), the computation unit 243 performs processing of operation S1206. For example, the computation unit 243 determines whether one of the light sources 220 adjacent to the light source 220 selected as an adjustment target may be selected as a new adjustment target (operation S1206). When one of the light sources 220 adjacent to the light source 220 selected as an adjustment target may be selected as a new adjustment target (Yes in operation S1206), the computation unit 243 selects the light source 220 as a new adjustment target. The process returns to operation S1202 in which the computation unit 243 temporarily determines the light emission intensity of the light source 220 which has been selected as a new adjustment target. The computation unit 243 performs the process from operation S1203 to operation S1204 for the new adjustment target.

When one of the light sources 220 adjacent to the light source 220 selected as an adjustment target may not be selected as a new adjustment target (No in operation S1206), the computation unit 243 determines whether there is another portion other than the portion selected in operation S1201 to which the smallest amount of light is supplied (operation S1207). When another portion to which the smallest amount of light is supplied is not present (No in operation S1207), the computation unit 243 terminates the increase rate adjustment processing.

On the other hand, when there is another portion to which the smallest amount of light is supplied (Yes in operation S1207), the computation unit 243 determines whether the light emission intensity of the light source 220 nearest to another portion or the light emission intensity of the light source 220 adjacent to the light source 220 nearest to another portion may be adjustable (operation S1208).

When the light emission intensity of the light source 220 is adjustable (Yes in operation S1208), the process returns to operation S1201 in which the computation unit 243 selects the light source 220 as an adjustment target. The computation unit 243 performs the process from operation S1202 to operation S1207. On the other hand, when the light emission intensity of the light source 220 is not adjustable (No in operation S1208), the computation unit 243 terminates the increase rate adjustment processing.

When the light insufficiency problem has been overcome (Yes in operation S1204), the process proceeds to operation S1207.

After the increase rate adjustment processing has ended, the process proceeds to operation S1013.

After the reduction rate adjustment processing illustrated in FIG. 11 and the increase rate adjustment processing illustrated in FIG. 12 have ended, the computation unit 243 outputs an adjustment instruction to the light emission intensity control unit 244. The computation unit 243 outputs a correction instruction to correct values of pixels of a display target image to the image correction unit 245 in synchronization with the adjustment of light emission intensities of the light sources 220.

### Effect of Second Embodiment

According to the second embodiment, the display apparatus 200 performs correction processing so that a luminance level required for a display target image is reduced in accordance with an ambient illumination level. As a result, the display apparatus 200 may increase the interval between the luminance distribution pattern of the display target image and the combined light emission pattern of the light sources 220. As compared with adjustment processing performed without increasing the interval between a luminance distribution pattern and a combined light emission pattern, adjustment processing may be more flexibly performed. The display apparatus 200 includes a plurality of light sources whose light emission areas overlap one another. For example, in the display apparatus 200, a single pixel in the light control unit 210 receives light from a plurality of light sources. Since the luminance level of the pixel is achieved with the light emitted from these light sources, the light is effectively used. For example, according to this embodiment, the number of light sources whose light emission intensity may be reduced to reduce power consumption is increased from one to two or more. Accordingly, the display apparatus 200 according to the second embodiment may achieve reduction in a larger amount of power consumption.

According to the second embodiment, the display apparatus 200 calculates a corrected luminance level equivalent value from a value of a pixel of a display target image with the variable W set in accordance with an ambient illumination level. Accordingly, it is possible to appropriately correct the value of the pixel of the display target image in accordance with an ambient illumination level.

According to the second embodiment, the display apparatus 200 calculates a luminance level equivalent value by converting a value of a pixel of a display target image with the maximum pixel value of the display target image, and corrects the luminance level equivalent value to obtain the corrected luminance level equivalent value. The display apparatus 200 according to the second embodiment may appropriately correct a luminance level equivalent value of a display target image.

In the second embodiment, the light emission intensity of the light sources 220 is adjusted in accordance with an ambient illumination level. However, for example, adjustment processing may be performed so that the light emission intensity of the light sources 220 is reduced when an energy saving mode or the like is set by a user. In this case, it is possible to further reduce power consumption caused by the light emission of light sources in response to a user's request.

In the second embodiment, luminance level equivalent values included in each piece of line information calculated from a reduced image of a display target image are corrected with the variable W in accordance with an ambient illumination level. However, for example, the variable W may be changed so that a luminance level equivalent value is reduced in a bright area on the basis of the distribution of pixel values of a display target image.

### Third Embodiment

### (1) Correction of Combined Light Emission Pattern

In the second embodiment, the interval between the luminance distribution pattern of a display target image and a combined light emission pattern formed by the light sources 220 is increased by correcting luminance level equivalent values of the display target image. However, the level of the combined light emission pattern formed by the light sources 220 may be virtually increased.

For example, the display apparatus 200 sets the variable W to 0.8 in accordance with an ambient illumination level, and assumes that the amount of light emitted from each of the light sources 220 is 100%/W, e.g., each of the light sources 220 may emit light at a light emission intensity of 125%. By virtually setting the maximum light emission intensity, it is possible to increase the difference between a luminance distribution of a display target image and a combined light emission distribution obtained when light sources emit light at the virtual maximum light emission intensity.

Under the assumption that each of the light sources 220 may emit light at the virtual maximum light emission intensity of 125%, the display apparatus 200 performs a process similar to the above-described process according to the second embodiment (see FIG. 10). For example, the display apparatus 200 calculates a combined light emission pattern when each of the light sources 220 may emit light at the light emission intensity of 125%. Like in the second embodiment, in the third embodiment, the display apparatus 200 compares the combined light emission pattern and the luminance distribution pattern with each other and performs the reduction rate adjustment processing or the increase rate adjustment processing (see FIG. 12). In the above description, it is assumed that each of the light sources 220 emits light at the light emission intensity of 125%. However, it may be assumed that a certain one of the light sources 220 emits light at the light emission intensity of 120%.

After the reduction rate adjustment processing or the increase rate adjustment processing has been performed, the display apparatus 200 corrects the light emission intensity of each of the light sources 220 by multiplying the light emission intensity by the variable W of 0.8. For example, by multiplying the light emission intensity set for each of the light sources 220 by the variable W, the maximum light emission intensity of each of the light sources 220 becomes 100%. The light emission intensity control unit 244 performs control processing so that each light source emits light at the corrected light emission intensity.

As described previously, by performing correction processing so that the level of a combined light emission pattern formed by the light sources 220 is virtually increased, the display apparatus 200 may increase the interval between the luminance distribution pattern of a display target image and the combined light emission pattern. For example, the display apparatus 200 may increase the maximum light emission intensity of each light source to the virtual maximum light emission intensity. When it is assumed that a certain light source emits light to a pixel at a virtual light emission intensity, other light sources that emit light to the pixel may use the light virtually emitted from the certain light source. For example, even if the light emission intensities of other light sources are relatively small, a luminance level required for the pixel may be achieved with the light emitted from the certain light source. Accordingly, it is possible to significantly reduce power consumption when the light emission intensity is multiplied by the variable W. Thus, an effect similar to that obtained in the second embodiment may be acquired.

### (2) Configuration of Apparatus

Each component of the display apparatus 200 illustrated in FIG. 3 is conceptual in function, and is not necessarily physically configured as illustrated in FIG. 3. For example, the specific patterns of distribution and unification of the display apparatus 200 are not limited to those illustrated in FIG. 3. For example, the generation unit 242, the computation unit 243, and the light emission intensity control unit 244 may be functionally or physically unified. The computation unit 243 may be functionally distributed. For example, the computation unit 243 may be divided into a functional unit for controlling the entire process illustrated in FIG. 10, a functional unit for performing the reduction rate adjustment processing illustrated in FIG. 11, and a functional unit for performing the increase rate calculation processing illustrated in FIG. 12. Thus, all or part of the components in the display apparatus 200 may be functionally or physically distributed or unified in arbitrary units according to various loads and the state of use.

### (3) Program for Causing Computer to Perform Processing of the Display Apparatus 200

The above-described various processes (see, for example, FIGS. 10 to 12) performed by the display apparatus 200 may be achieved by executing a program provided in advance in a computer system such as a personal computer or a workstation, for example.

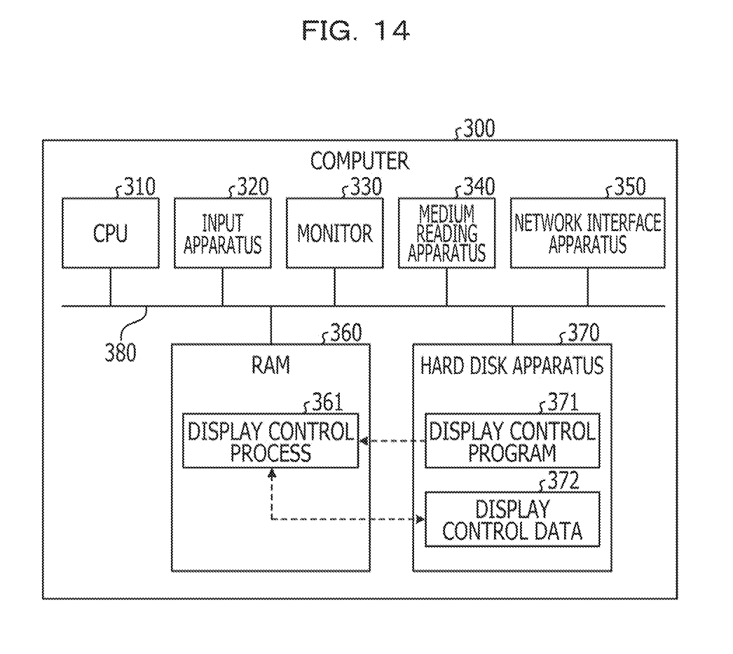

An example of a computer for performing a display control program with which a process similar to the process of the display apparatus 200 described in the second embodiment may be achieved will be described below with reference to FIG. 14. FIG. 14 is a diagram illustrating an example of a computer for executing a display control program.

As illustrated in FIG. 14, a computer 300 functioning as the display apparatus 200 includes a Central Processing Unit (CPU) 310, an input apparatus 320, and a monitor 330. The CPU 310 performs various pieces of computation processing. The input apparatus 320 receives data from a user. The monitor 330 includes the light control unit 210.

Furthermore, as illustrated in FIG. 14, the computer 300 includes a medium reading apparatus 340, a network interface apparatus 350, a Random Access Memory (RAM) 360, and a hard disk apparatus 370. The CPU 310, the input apparatus 320, the monitor 330, the medium reading apparatus 340, the network interface apparatus 350, the RAM 360, and the hard disk apparatus 370 are connected to a bus 380. The medium reading apparatus 340 reads out a program or the like from a storage medium. The network interface apparatus 350 transmits/receives data to/from another computer via a network. The RAM 360 temporarily stores various pieces of information.

The hard disk apparatus 370 stores a display control program 371 with which a function similar to that of the display apparatus 200 is achieved and display control data 372. The display control program 371 may be distributed as appropriate to be stored in a storage unit of another computer communicably connected to the computer 300 via a network.

The CPU 310 reads out the display control program 371 from the hard disk apparatus 370 and decompresses the display control program 371 onto the RAM 360. As illustrated in FIG. 14, the display control program 371 functions as a display control process 361. The display control process 361 extracts information or the like from the display control data 372, decompresses the extracted information in an assigned area in the RAM 360 as appropriate, and performs various pieces of processing on the basis of decompressed various pieces of data.

For example, the display control process 361 corresponds to a process performed by the generation unit 242, the computation unit 243, the light emission intensity control unit 244, and the image correction unit 245 illustrated in FIG. 3.

The display control program 371 is not necessarily stored in the hard disk apparatus 370 in advance. For example, the display control program 371 may be stored in a portable physical medium such as a flexible disk (FD), a compact-disk read-only memory (CD-ROM), a digital versatile disk (DVD), an magneto-optical disk, or an IC card inserted in the computer 300, and may be read by the computer 300 from the portable physical medium for execution.

Each program may be stored in another computer (or another server) connected to the computer 300 via a public line, the Internet, a Local-Area Network (LAN), a Wide-Area Network (WAN), or the like, and may be read by the computer 300 from the computer (or the server) for execution.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A display apparatus in which a plurality of light sources emit light to a pixel comprising:
a correction unit configured to correct a luminance distribution of a display target image or a light emission distribution obtained when the plurality of light sources emit light at a certain light emission intensity so that an interval between the luminance distribution and the light emission distribution is increased; and
a control unit configured to control an amount of light emitted from each of the plurality of light sources based on the luminance distribution or the light emission distribution corrected by the correction unit.

2. The display apparatus according to claim 1, further comprising an acquisition unit configured to acquire an illumination level in proximity to the display apparatus, and
wherein the correction unit calculates a corrected luminance distribution by reducing a luminance level of the display target image in accordance with the illumination level acquired by the acquisition unit so as to increase the interval between the luminance distribution and the light emission distribution, and
wherein the control unit controls the amount of light emitted from each of the plurality of light sources based on the corrected luminance distribution calculated by the correction unit.

3. The display apparatus according to claim 2, wherein the correction unit calculates an adjustment amount that is an amount of reduction in luminance level based of the illumination level acquired by the acquisition unit and calculates the corrected luminance distribution based on the adjustment amount.

4. The display apparatus according to claim 2, wherein the correction unit calculates an adjustment amount based on a maximum luminance level of the display target image and calculates the corrected luminance distribution based on the adjustment amount.

5. The display apparatus according to claim 1, further comprising an acquisition unit configured to receive an instruction to reduce the amount of light emitted from each of the plurality of light sources, and
wherein, in response to the instruction acquired by the acquisition unit, the correction unit calculates the corrected luminance distribution by reducing a luminance level of the display target image so as to increase the interval between the luminance distribution and the light emission distribution, and
wherein the control unit controls the amount of light emitted from each of the plurality of light sources based on the corrected luminance distribution calculated by the correction unit.

6. The display apparatus according to claim 5, wherein the correction unit calculates an adjustment amount based on the instruction acquired by the acquisition unit and calculates the corrected luminance distribution on the basis of the adjustment amount.

7. The display apparatus according to claim 5, wherein the correction unit calculates an adjustment amount based on a maximum luminance level of the display target image and calculates the corrected luminance distribution based on the adjustment amount.

8. The display apparatus according to claim 1, further comprising an acquisition unit configured to acquire an illumination level in proximity to the display apparatus, and
wherein the correction unit calculates a corrected light emission distribution by increasing a luminance level obtained from the light emission distribution in accordance with the illumination level acquired by the acquisition unit so as to increase the interval between the luminance distribution and the light emission distribution, and
wherein the control unit controls the amount of light emitted from each of the plurality of light sources based on the corrected light emission distribution calculated by the correction unit.

9. The display apparatus according to claim 1, further comprising an acquisition unit configured to receive an instruction to reduce the amount of light emitted from each of the plurality of light sources, and
wherein, in response to the instruction acquired by the acquisition unit, the correction unit calculates the corrected light emission distribution by increasing a luminance level obtained from the light emission distribution so as to increase the interval between the luminance distribution and the light emission distribution, and
wherein the control unit controls the amount of light emitted from each of the plurality of light sources based on the corrected light emission distribution calculated by the correction unit.

10. A display method executed by a display apparatus in which a plurality of light sources emit light to a pixel, comprising:
correcting a luminance distribution of a display target image or a light emission distribution obtained when the plurality of light sources emit light at a certain light emission intensity so that an interval between the luminance distribution and the light emission distribution is increased; and
controlling an amount of light emitted from each of the plurality of light sources based on the corrected luminance distribution or the corrected light emission distribution.

11. The display method according to claim 10, further comprising acquiring an illumination level in proximity to the display apparatus, and
wherein the correcting calculates the corrected luminance distribution by reducing a luminance level of the display target image in accordance with the acquired illumination level so as to increase the interval between the luminance distribution and the light emission distribution, and
wherein the controlling controls amount of light emitted from each of the plurality of light sources based on the corrected luminance distribution.

12. The display method according to claim 11, wherein the correcting calculates an adjustment amount that is an amount of reduction in luminance level based on the acquired illumination level, and calculates the corrected luminance distribution based on the adjustment amount.

13. The display method according to claim 12, wherein the correcting calculates the adjustment amount based on a maximum luminance level of the display target image and calculates the corrected luminance distribution based on the adjustment amount.

14. The display method according to claim 10, further comprising receiving an instruction to reduce the amount of light emitted from each of the plurality of light sources, and
wherein the correcting calculates the corrected luminance distribution by reducing a luminance level of the display target image so as to increase the interval between the luminance distribution and the light emission distribution in response to the instruction, and
wherein the controlling controls the amount of light emitted from each of the plurality of light sources based on the calculated corrected luminance distribution.

15. The display method according to claim 14, wherein the correcting calculates an adjustment amount based on the basis of the acquired instruction and calculates the corrected luminance distribution based on the adjustment amount.

16. The display method according to claim 15, wherein the correcting calculates the adjustment amount based on a maximum luminance level of the display target image and calculates the corrected luminance distribution on the basis of the adjustment amount.

17. The display method according to claim 10, further comprising acquiring an illumination level in proximity to the display apparatus, and
wherein the correcting calculates the corrected light emission distribution by increasing a luminance level obtained from the light emission distribution in accordance with the acquired illumination level so as to increase the interval between the luminance distribution and the light emission distribution, and
wherein the controlling controls the amount of light emitted from each of the plurality of light sources based on the corrected light emission distribution.

18. The display method according to claim 10, further comprising receiving an instruction to reduce the amount of light emitted from each of the plurality of light sources, and
wherein the correcting calculates the corrected light emission distribution, in response to the acquired instruction, by increasing a luminance level obtained from the light emission distribution so as to increase the interval between the luminance distribution and the light emission distribution, and
wherein the controlling controls the amount of light emitted from each of the plurality of light sources based on the corrected light emission distribution.
